(19) United States
(12) Patent Application Publication
(10) Pub. No.: US 2003/0033429 A1
(43) Pub. Date: Feb. 13, 2003

(54) Information acquiring system, information processing device, information processing method, program, and medium

(76) Inventor: Yutaka Myoki, Kanagawa (JP)

Correspondence Address: FITZPATRICK CELLA HARPER & SCINTO, 30 ROCKEFELLER PLAZA, NEW YORK, NY, 10112, US

(21) Appl. No.: 10/198,156

(22) Filed: Jul. 19, 2002

(30) Foreign Application Priority Data
Jul. 30, 2001 (JP) 229642/2001

(51) Int. Cl. G06F 15/173

(52) U.S. Cl. 709/238

(57) ABSTRACT

The present invention allows a resource information management device to securely notify a resource information acquiring device of information about the address (URL) of a resource (information file) so that the resource information acquiring device can acquire the information file from a resource information transmitting device. The resource acquiring device previously stores, in storage means, a partial name of the address of a resource, then receives partial information about the address of the resource from the resource information management device, and generates the address of the resource, based on the address partial name stored in the storage means and the received partial information about the address, thereby acquiring the resource.

### BACKGROUND OF THE INVENTION

1. Field of the Invention

The present invention relates to an information acquiring system, an information processing device, an information processing method, a program, and a medium for acquiring information included in the information-processing device, using an address on a network.

2. Description of the Related Art

A technique is known in which, when computers interconnected via a network exchange file information (resource), a server on the information providing side notifies a client on the information acquiring side, of information about the location (address) where the file of interest is located, and in which the client acquires the file based on the address information from the server. For example, a URL (Uniform Resource Locator) is used in communication via the Internet, where the server notifies the client of the address of a file in the URL format, and the client can acquire the file using the transmitted URL.

However, in the above-described technique, if a URL is transmitted by an unsecure communication method, there is a possibility that the address of the file may be obtained by third parties other than the server and the client, thereby causing a security problem.

On the other hand, if a user directly inputs the URL into a client device and stores (by book marking) the URL in storage means in advance, in order to circumvent the transmission of the URL from the server to the client, it would take much time and labor for a user to input the URL for each file. Furthermore, if a URL, which indicates the address where the file of interest is located, is changed, the problem arises that the client could not acquire the file unless the URL is corrected by the user's operation.

### SUMMARY OF THE INVENTION

Accordingly, it is an object of the present invention to allow an information file to be acquired by causing an information providing device to notify an information acquiring device of the information about the address (URL) of the information file, while maintaining security.

To achieve the above-described object, the present invention provides an information acquiring system that transmits/receives a resource between a resource transmitting device and a resource receiving device via a resource management device. The resource managing device has resource information transmitting means that transmits partial information about the address of the resource to a resource receiving device. The resource receiving device comprises storage means that stores a partial name of the address of the resource; resource information receiving means that receives the partial information about the address of the resource, the partial information having been transmitted from the resource information transmitting means; generating means that generates an address of the resource, based on the stored partial name of the address and the received partial information about the address; and acquiring means that acquires the resource based on the generated resource address.

Also, to achieve the above-described object, the present invention provides an information processing device that comprises storage means that stores a partial name of the address of a resource; resource information receiving means that receives partial information about the address of the resource; generating means that generates the address of the resource, based on the stored partial name of the address and the received partial information about the address; and acquiring means that acquires the resource based on the generated resource address.

Moreover, to achieve the above-described object, the present invention provides an information processing device having resource information transmitting means that transmits partial information about an address of a resource to a resource receiving device. Herein, the resource receiving device-comprises storage means that stores a partial name of the address of a resource; resource information receiving means that receives partial information about the address of the resource; generating means that generates the address of the resource, based on the stored partial name of the address and the received partial information about the address; and acquiring means that acquires the resource based on the generated resource address.

Other features and advantages of the present invention will become apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram of an embodiment according to the present invention.

FIG. 2 is a flowchart showing the processing in a content provider according to the embodiment.

FIG. 3 is a flowchart showing the processing in a service provider according to the embodiment.

FIG. 4 shows an example of an internal configuration of an information processing device according to the present invention.

### DESCRIPTION OF THE PREFERRED EMBODIMENTS

In one embodiment, transmission/reception of contents (file information) is performed between a content provider (content transmitting side) and a service provider (content receiving side). A URL is used to designate a content location (address). As a communication channel, the Internet is used, and as a communication protocol, HTTP (Hyper Text Transfer Protocol) on TCP/IP is employed. All domain names used in this embodiment are ones described merely to identify devices, and are unrelated to any existing domain name.

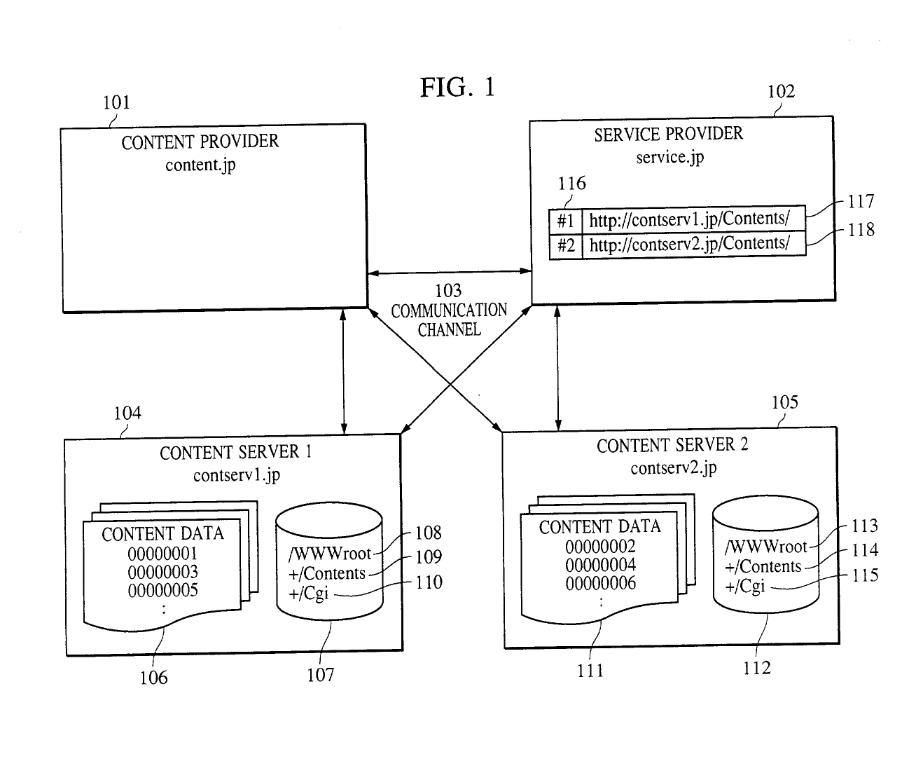

FIG. 1 is a block diagram of an embodiment according to the present invention.

Referring to FIG. 1, a content provider 101 is a computer that is TCP/IP-connected to the Internet, and is a device ion the content providing side. In this embodiment, the FQDN (Fully Qualified Domain Name) of this content provider 101 is assumed to be “content.jp”.

A service provider 102 is a computer that is TCP/IP-connected to the Internet, and that can be accessed by HTTP. The service provider 102 acquires contents by accessing the content server designated by the content provider, and executes a predetermined service using the above-mentioned acquired contents. Here, the predetermined service may be, for example, one that produces new information using the acquired contents, and that transmits the produced information to a user terminal (not shown) receiving provided services. The service provider 102 may additionally execute other various services using the acquired contents. Here, the FQDN of the service provider 102 is assumed to be “service.jp”. It is assumed, furthermore, that the service provider 102 can execute a CGI (Common Gateway Interface) program, and that, when an execution request is given from the content provider 101 to the URL of the CGI program: “http://service.jp/Cgi/cgi.exe, the service provider 102 executes the CGI program. Herein, the “http” portion of the above-mentioned URL is a scheme, and here means the usage of the HTTP protocol. The “Cgi/cgi.exe” portion is the path name of the URL, and means the address (location) when a resource in the service provider 102 is viewed from the outside. This address, when viewed from the outside, is mapped into the internal address (location) of the service provider 102 by the HTTP processing program of the service provider 102.

As a communication channel 103, the Internet is used in this embodiment. The communication channel 103 is constituted by interconnecting the content provider 101, the service provider 102, a content server 1 (104), and a content server 2 (105).

In the content provider 101, in order to disperse the load on the computing equipment, two computers serve as content servers: the content server 1 (104) and the content server 2 (105), which are interconnected via the network. Both content servers are computers capable of connecting to TCP/IP resident on the Internet, and capable of accessing HTTP. Here, the FQDN of the content server 1 (104) is assumed to be “contserv1.jp”, and that of the content server 2 (105) is assumed to be “contserv2.jp”. It is assumed, moreover, that the content server 1 (104) and the content server 2 (105) can execute a CGI program, and that the URLs of the CGI programs that are given execution requests from the content provider 101, are “http://contserv1.jp/Cgi/cgi.exe” and “http://contserv2.jp/Cgi/cgi.exe”, respectively. In this embodiment, the content provider and the content servers are discrete devices. Alternatively, however, the content provider may be arranged to also serve as the content servers.

Contents provided by the content server 101 are given 8-digit decimal serial numbers, i.e., 00000001 to 99999999, as file names. In the content server 1 (104), among the contents provided by the content provider 101, odd-numbered serial numbers as file names, i.e., 00000001, 00000003, 00000005, . . . are assumed to be stored in a data base 106. On the other hand, in the content server 2 (105), among the contents provided by the content provider 101, even-numbered serial numbers as file names, i.e., 00000002, 00000004, 00000006 . . . are assumed to be stored in a data base 111.

Reference numeral 107 denotes a fixed memory for the content server 1 (104). The fixed memory 107 includes a directory accessible from the outside via the network. Reference numeral 108 denotes an internal directory on the fixed memory 107, which is here assumed to be “/WWWroot”. In the content server 1 (104), the root of a URL path name using HTTP scheme is assumed to be mapped into the directory “/WWWroot” 108. Specifically, a URL: “http://contserv1.jp/” is mapped into the directory “/WWWroot” 108 on the fixed memory 107 in the content server 1 (104). Reference numeral 109 denotes a sub-directory of the directory 108. The sub-directory 109 is here assumed to be “/WWWroot/Contents”. In the content server 1 (104), a URL path name “/Contents” using HTTP scheme is mapped into the sub-directory 109. Specifically, a URL: “http://contserv1.jp/Contents/” is mapped into the sub-directory 109 on the fixed memory 107 in the content server 1 (104). Likewise, reference numeral 110 denotes a directory “/WWWroot/Cgi” on the fixed memory 107. A URL: “http://contserv1.jp/cgi/” is mapped into the directory 110 in the content server 1 (104). A CGI program: “cgi.exe” executable by the content provider 101, is placed into the directory 110, and a URL: “http://contserv1.jp/Cgi/cgi.exe” is mapped into this CGI program.

As in the case of the content server 1 (104), in the content server 2 (105), reference numeral 112 denotes a fixed memory for the content server 2. The fixed memory 112 includes a directory accessible from the outside via the network. Reference numeral 113 denotes a directory on the fixed memory 112. A URL: “http://contserv2.jp/” is mapped into the directory 113 on the fixed memory 112 in the content server 2 (105). Reference numerals 114 and 115 denote sub-directories of the directory 113. A URL: “http://contserv2.jp/Contents/” is mapped into the directory 114, and a URL: “http://contserv2.jp/Cgi/” is mapped into the directory 115. A CGI program “cgi.exe” is placed into the directory 115.

Reference numeral 116 denotes a URL base information table stored in the service provider 102. The URL base information table is required to have as many pieces of URL base information as the number of content servers that the content provider 101 may use. These content servers are made distinguishable from one another by uniquely assigned numbers. Herein, because there are provided two content servers, the URL base information table 116 has information of two content servers stored therein. Reference numeral 117 designates URL base information with an identifier number, “#1” assigned. As information of a content server, “http://contserv1.jp/Contents/” is stored in correspondence with the identifier “#1”. Reference numeral 118 designates URL base information with an identifier number, “#2” assigned. As information of the other content server, “http://contserv2.jp/Contents/” is stored in correspondence with the identifier “#2”.

In this embodiment, in order to provide the service provider 102 with contents, the content provider 101 causes the content server used for content transmission to prepare the contents, and notifies the service provider 102 of information about the content server of an access destination, this information being one for generating a URL for acquisition, and in this embodiment, this information comprising a content server identifier and a file name. The service provider 102 acquires contents from the content server 1 (104) or the content server 2 (105) based on the transmitted information.

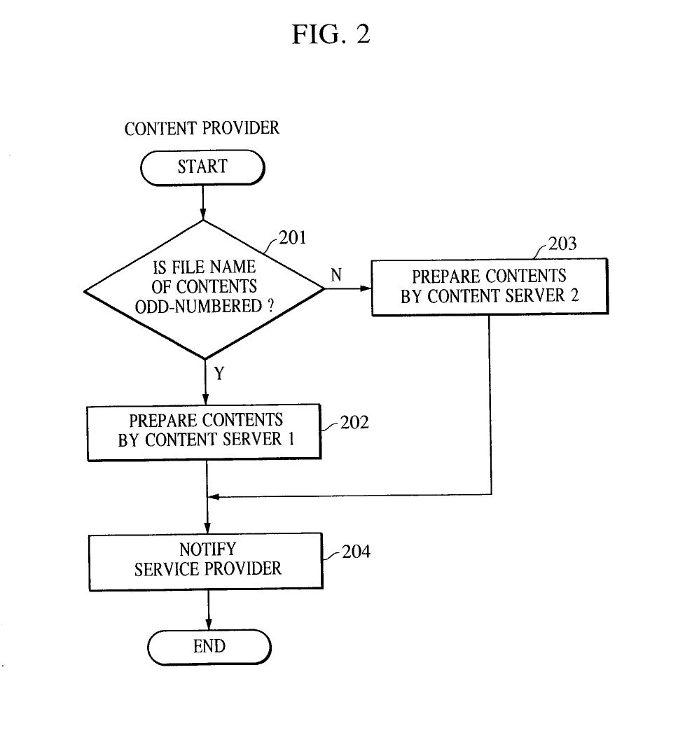

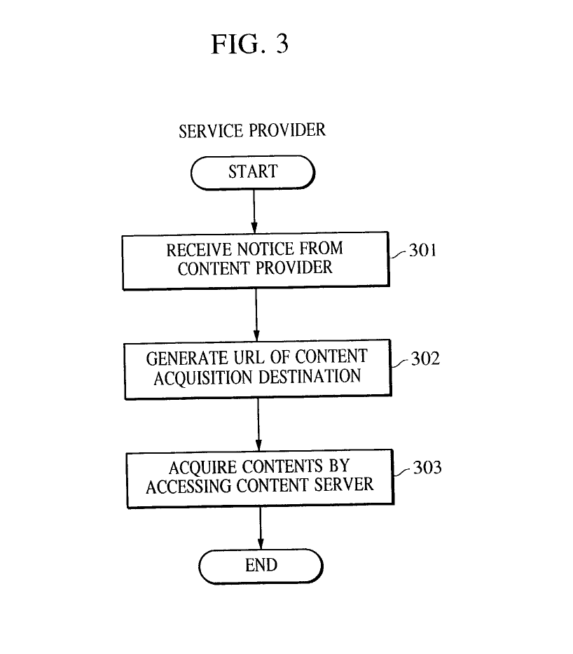

Next, the processing executed by the content provider 101 and the service provider 102 will be described in detail with reference to FIGS. 2 and 3.

FIG. 2 is a flowchart showing the processing executed by the content provider 101.

In step 201, the file name of the contents that the service provider is caused to acquire is determined, and it is determined whether to cause the service provider to acquire the file from the content server 1 (104), or from the content server 2 (105). In this embodiment, the file name of contents is given a decimal serial number. In step 201, it is determined whether or not the file name is odd-numbered, by using the content server 1 (104) when the file name is odd-numbered, and using the content server 2 (105) when the file name is even-numbered.

When the file name is odd-numbered, at step 202, the content provider 101 instructs the content server 1 (104) to prepare the relevant contents. Herein, a CGI program arranged for the content server 1 (104) is used. When the file name of the above-mentioned contents is, for example, 00000017, the URL for CGI program calling that is transmitted from the content provider 101 to the content server 1 (104) is assumed to be “http://contserv1.jp/Cgi/cgi.exe?file=00000017. Here, the portion after “?” of this URL is an argument for the CGI program calling. It is determined in advance as a calling regulation between the content provider 101 and the content server 1 (104) that the portion “file=” is fixed and the portion “00000017” is the designation of the file name of the contents. At this time, according to the URL path name before “?” of the above-mentioned URL, the CGI program of the content server 1 (104), “/WWWroot/Cgi/cgi.exe” is read out and executed. According to the aforesaid calling regulation, this CGI program extracts the file name “00000017” from the above-mentioned URL. Next, the contents with the file name “00000017” are taken out from the data base 106, and are copied to the directory 109 on the fixed memory 107, the directory 109 being open to the outside. The file name of these contents on the fixed memory 107 is “/WWWroot/Contents/00000017”.

On the other hand, at step 201, if the file name of the contents is determined to be even-numbered, the processing proceeds to step 203, and the content provider 101 instructs the content server 2 (105) to prepare the relevant contents. The processing at step 203 is the same as step 202 except that the content server 2 (105) replaces the content server 1 ,(104).

At step 204, the content provider 101notifies the service provider 102 of information about the content acquisition location. Herein, a CGI program arranged for the service provider 102 is used. When the file name of contents is, for example, 00000017, the URL for CGI program calling that is transmitted from the content provider 101 to the service provider 102 is assumed to be “http://service.jp/cgi.exe?host=#1&file=00000017. Here, the portion after “?” of this URL is an argument for the CGI program calling, and “&” is a delimiter between arguments. That is, a first argument is “host=#1”, and a second one is “file=00000017”. It is assumed to be determined in advance as a calling regulation between the content provider 101 and the service provider 102 that, with regard to the first argument, the portion “host=” is fixed and the portion “#1” is the designation of the content server number, and that, with regard to the second argument, the portion “file=” is fixed and “00000017” is the designation of the file name of the contents.

FIG. 3 is a flowchart showing the processing executed by the service provider 102.

At step 301, the service provider 102 receives the URL: “http://service.jp/cgi.exe?host=#1&file=00000017 transmitted from the content provider 101 at step 20.4.

At step 302, according to the received URL, the CGI program is called up, and in compliance with the above-described calling regulation, the content server number “#1” and the file name “100000017” are extracted from the aforesaid URL.

From the extracted content server number “#1” and the file name “0,0000017”, the URL of a content acquisition destination is generated at step 302. Specifically, with the content server number and the file name gained, the acquisition destination URL is generated by utilizing the content server number and the file name as well as URL base information 116. When the content server number is “#1” and the file name is “00000017”, by making a reference to the URL base information 116, the URL corresponding to the content server number “#1” is found to be “http://contserv1.jp/Contents/” (117). Next, by combining the gained URL and the file name “00000017”, the acquisition destination URL: http://contserv1.jp/Contents/00000017 is generated.

At step 303, according this generated acquisition destination URL, the relevant contents are acquired by making HTTP access to the content server 1 (104). As a result, the service provider executes the services to be provided by the service provider, using the acquired relevant contents.

Upon receipt of the designated URL from the service provider 102, the content server 1 (104) maps the above-described ,URL path name “/Contents/00000017” into the internal address of the content server 1 (104), i.e., “/WWWroot/Contents/00000017”. After taking out the mapped contents, the content server 1 (104) transmits them to the service provider .102.

As described above, in this embodiment, instead of transmitting a URL itself over a communication channel, the content provider notifies the service provider of the location where the contents are located, and causes the service provider to generate a URL by itself to acquire the contents. This results in increased security.

Also, in this embodiment, the content provider is arranged to notify the service provider of the information for identifying an acquisition destination server and the information about the contents and, therefore, even if the acquisition destination of a content file is changed, the service provider will be able to reliably acquire the file.

Other Embodiments

In the above-described embodiment, the content provider, the content servers, and the service provider have each been used as computers TCP-IP connectable to the Internet. Alternatively, however, they are not limited to ones complying with this type of protocol. Any other protocols that allow interactive communication may also be applied.

Also, a URL has been used as a method for designating the location of a resource, but the method for designating a resource is not restricted to the URL. Any other method that can designate the address of a resource (information file), such as URN (Uniform Resource Name) or widely URI (Uniform Resource Indicator), may also be used.

HTTP has been used as a protocol during communication, but the protocol during communication is not limited to HTTP. Any other protocol that is usable on both resource transmitting and receiving sides, such as FTP (File Transfer Protocol) or HTTPS (HTTP Security), may also be employed.

Any port number has been omitted in the URL notation using the HTTP protocol. This is because, in RFC (Request For Comment) 1738 (Uniform Resource Locators (URL)) and RFC 1945 (Hypertext Transfer Protocol—HTTP/1.0) of IETF (Internet Engineering Task Force), it is specified that, if the port number is omitted, the default port number is 80. Of course, the port number may be explicitly designated depending on the method for practicing the invention.

Alternatively, another port number may also be explicitly designated.

The Internet has been used as a communication channel, but the communication channel is not restricted to the Internet. Any medium which allows interactive communication between computers, such as personal-computer communication or a private (or privately leased) line, may be generally used, irrespective of configuration.

For load dispersion, two computers are used: the content servers 1 and 2, but more computers than the two may be used. Alternatively, only one computer may also be employed.

The relationship between the content server 1 and the content server 2 has been arranged so that they play equal roles for dispersing load. However, the method for distributing load is free. For example, a method in which a particular computer is charged with concentrated load and the remaining computer is used for backup, may be adopted. Also, in the above-described embodiment, as a load dispersing method, the method in which contents are distributed in equal proportion to the two computers has been used, but the load dispersing method is not limited to this one. Any load dispersing method is usable, such as the method in which, with the two computers provided with the same contents, the content provider allocates load to the two computers according to the actual load at the point in time, or the method using a round robin scheduling in which the content servers are sequentially given load every time an access request is-issued.

As the file name of contents, an 8-digit decimal serial number has been assumed to be given, but the file name is not restricted to this nomenclature. Any name that complies with the nomenclature defined by content storage means used by a computer, may be used.

At step 204, when the content provider notifies the service provider of the content acquisition location, a content server identification number and a file name are transmitted from the content provider to the service provider. Instead of the file name, however, “sub-directory name+file name” may be transmitted. In this case, the content provider should instruct the content server to prepare the content file in the above-mentioned sub-directory, at step 203.

In the content server, contents have been assumed to be stored in a data base. However, any means that allows a content file to be permanently stored, and that allows the content file to be acquired using some type of key, may be used to store contents.

As the directory name on a fixed memory, “/WWWroot” or another designation has been used, but these are just a few examples. Other designations may also be employed.

A CGI program has been used for the communication of the content provider with the content servers and the service provider. However, the communication of the content provider with them does not necessarily involve using a CGI program. Any program that allows required information to be transmitted from a communication source to a communication destination, is usable irrespective of form.

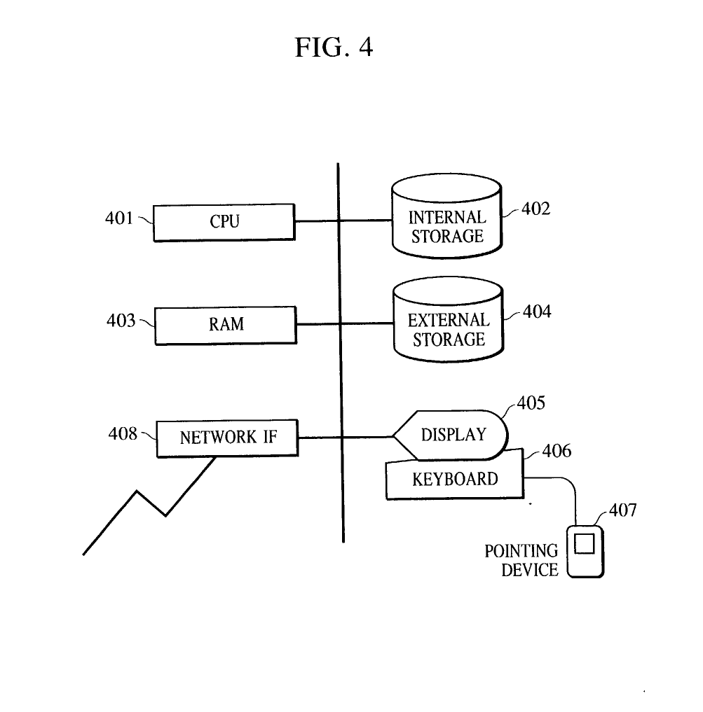

FIG. 4 shows an example of a configuration of an information processing device operable as any one of the content provider, the content server 1, the content server 2, and the service provider. Referring to FIG. 4, reference numeral 401 denotes a CPU that controls the entire device according to a control program stored in a ROM 402 (any one of the program for the content provider, the programs for the content servers, and the program for the service provider). Reference numeral 402 denotes an internal storage portion, such as a ROM or an HDD storing the control program for this device that includes the processing shown in the above-described flowcharts, the processing being executed by the CPU 401. Reference numeral 403 denotes a RAM storing documents and/or images, and providing working areas for the CPU 401, and 404 denotes an external storage such as a magnetic disk. Reference numeral 405 designates a display, 406 designates a keyboard, and 407 designates a pointing device such as a mouse. Reference numeral 408 designates a network interface, which-communicates with devices interconnected via the network and which transmits/receives programs and/or data. Herein, for implementing the present embodiments, the CPU 401 may be arranged to execute the control program by reading it from the internal storage portion 402, or from the external storage device 404. Alternatively, the CPU 401 may be arranged to execute the control program by receiving it from an external device interconnected via the network.

As is evident from the foregoing, according to the present embodiments, instead of transmitting a URL itself over a communication channel, by notifying the resource receiving device of partial information for designating the address of a resource (file information), the resource receiving device is arranged to generate the address by itself to acquire the resource, thereby achieving an improvement in security.

Moreover, even if the resource acquisition destination is changed, the resource receiving device will be able to reliably acquire the resource.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of following-claims is to be accorded the broadest interpretation so as to encompass all such modifications and equivalent-structures and functions.

What is claimed is:

1. An information acquiring system that transmits/receives a resource between a resource transmitting device and a resource receiving device via a resource management device, said resource managing device having resource information transmitting means that transmits partial information about an address of said resource to the resource receiving device, and said resource receiving device comprising:
storage means that stores a partial name of the address of said resource;
resource information receiving means that receives the partial information about the address of said resource, said partial information having been transmitted from said resource information transmitting means;
generating means that generates the address of said resource, based on said stored partial name of the address and said received partial information about the address; and
acquiring means that acquires said resource based on said generated resource address.

2. An information processing device, comprising:
storage means that stores a partial name of an address of a resource;
resource information receiving means that receives partial information about the address of said resource;
generating means that generates the address of said resource, based on said stored partial name of the address and said received partial information about the address; and
acquiring means that acquires said resource based on said generated resource address.

3. An information processing device according to claim 2,
wherein the partial name of the address of the resource stored in said storage means includes the address of a resource transmitting device, and
wherein said partial name of the address of the resource is stored in correspondence with an identifier of said resource transmitting device.

4. An information processing device according to claim 3, wherein said received partial information about the address of the resource includes the identifier of said resource transmitting device.

5. An information processing device according to claim 2,
wherein the partial name of the address of the resource stored in said storage means includes a directory address of the resource transmitting device where said resource is located, and
wherein the partial information received by said resource information receiving means includes a name of said resource and information that designates the directory address of the resource transmitting device, said directory address being stored in said storage means.

6. An information processing device, comprising:
resource information transmitting means that transmits partial information about an address of a resource to a resource receiving device, said resource receiving device comprising:
storage means that stores a partial name of the address of the resource;
resource information receiving means that receives partial information about the address of said resource;
generating means that generates the address of said resource, based on said stored partial name of the address and said received partial information about the address; and
acquiring means that acquires said resource based on said generated resource address.

7. An information processing device according to claim 6, further comprising preparation instructing means that instructs the resource transmitting device for transmitting said resource, to prepare so that said resource receiving device can acquire said resource.

8. An information processing method, comprising the steps of:
receiving partial information about an address of a resource;
generating the address of said resource, based on an address partial name of the resource stored in storage means and said received partial information about the address; and
acquiring said resource based on said generated resource address.

9. An information processing method according to claim 8,
wherein said address partial name of the resource stored in said storage means includes an address of a resource transmitting device, and
wherein said address partial name of the resource is stored in correspondence with an identifier of said resource transmitting device.

10. An information processing method according to claim 9, wherein said received partial information about the address of the resource includes the identifier of said resource transmitting device.

11. An information processing method according to claim 9,
wherein the address partial name of the resource stored in the storage means includes a directory address of the resource transmitting device where said resource is located, and
wherein the partial information received by said resource information receiving step includes a name of said resource and information that designates the directory address of the resource transmitting device, said directory address being stored in said storage means.

12. An information processing method comprising the step of transmitting partial information about an address of a resource to a resource receiving device, said resource receiving device performing the steps of:
storing a partial name of the address of the resource;
receiving partial information about the address of said resource;
generating the address of said resource, based on said stored address partial name and said received partial information about the address of the resource; and
acquiring said resource based on said generated resource address.

13. An information processing method according to claim 12, further comprising a preparation instructing step of instructing a resource transmitting device for transmitting said resource, to prepare so that said resource receiving device can acquire said resource.

14. A computer-executable program including program codes for causing a computer to execute, said program codes comprising the steps of:
receiving partial information about an address of a resource;
generating the address of said resource, based on an address partial name of the resource stored in storage means and the partial information about said received address; and
acquiring said resource based on said generated resource address.

15. A computer-executable program according to claim 14,
wherein said address partial name of the resource stored in said storage means includes an address of a resource transmitting device, and
wherein said address partial name of the resource is stored in correspondence with an identifier of said resource transmitting device.

16. A computer-executable program according to claim 15, wherein said received partial information about the address of the resource includes the identifier of said resource transmitting device.

17. A computer-executable program according to claim 14,
wherein the address partial name of the resource stored in the storage means includes a directory address of the resource transmitting device where said resource is located, and
wherein the partial information received by said resource information receiving step includes a name of said resource and information that designates the directory address of the resource transmitting device, the directory address being stored in said storage means.

18. A computer-executable program including program codes for causing a computer to execute the step of transmitting partial information about an address of a resource to a resource receiving device, said resource receiving device performing the steps of:
storing a partial name of the address of the resource;
receiving the partial information about the address of said resource;
generating the address of said resource, based on said stored address partial name and said received partial information about the address; and
acquiring said resource based on said generated resource address.

19. A computer-executable program according to claim 18, further comprising preparation instructing a resource transmitting device for transmitting said resource, to prepare so that said resource receiving device can acquire said resource.

20. A computer-readable storage medium that stores program codes for causing a computer to execute the steps of:
receiving partial information about an address of a resource;
generating the address of said resource, based on an address partial name of the resource stored in storage means and the partial information about said received address; and
acquiring said resource based on said generated resource address.

21. A computer-readable storage medium that stores program codes for causing a computer to execute the step of transmitting partial information about an address of a resource to a resource receiving device, said resource receiving device performing the steps of:
storing a partial name of the address of the resource;
receiving the partial information about the address of said resource;
generating the address of said resource, based on said stored address partial name and said received partial information about the address; and
acquiring said resource based on said generated resource address.
